(19) United States
(12) Patent Application Publication
(10) Pub. No.: US 2015/0269691 A1
(43) Pub. Date: Sep. 24, 2015

(54) LEGAL REASONING GRAPHS AND USAGE THEREOF

(71) Applicant: ModusP, Inc., Tel Aviv (IL)

(72) Inventors: Tom BAR YACOV, Haifa (IL); Nimrod GLIKSMAN, Tel Aviv (IL)

(73) Assignee: ModusP, Inc., Tel Aviv (IL)

(21) Appl. No.: 14/221,047

(22) Filed: Mar. 20, 2014

(51) Int. Cl. G06Q 50/18; G06F 17/30

(52) U.S. Cl. CPC G06Q 50/18; G06F 17/30696; G06F 17/30663

(57) ABSTRACT

A computer implemented method, a computerized apparatus and a computer program product for legal reasoning graph and usage thereof. The computer implemented method comprising obtaining a query from a user; searching in a repository of legal reasoning graphs, wherein the searching is based on the query, wherein each legal reasoning graph in the repository is a graph composed of legal reasonings that cite one another, wherein each legal reasoning is one or more paragraphs extracted from a legal document, wherein in response to the searching, obtaining a result legal reasoning graph; and outputting the result legal reasoning graph.

### TECHNICAL FIELD

The present disclosure relates to information technologies in general, and to computer-aided search and display of legal reasonings, in particular.

### BACKGROUND

Law professionals spend many man hours conducting research of legal documents, such as case law, papers, textbooks, or the like in order to analyze the current state of the law and infer the current up-to-date controlling legal reasoning.

Search engines allow the legal professional to execute search queries in order to documents that are most relevant to the search query. The search is conducted by identifying documents that use the same keywords that appear in the query and by scoring. The scoring is often performing using cosine similarity between a K-dimensional vector representing the document and a vector representing the query. The K-dimensional vector may include a measurement associated with each keyword appearing in the query, such as for example term frequency, inverse document frequency and a combination thereof.

The search results are presented to the user in a list which is sorted based on the score itself and regardless of contextual connectivity between the various search results. As a result, a non-controlling decision or even an overturned decision may be presented in a high position in the search results, above better legal reasonings that are controlling.

### BRIEF SUMMARY

One exemplary embodiment of the disclosed subject matter is an apparatus having a processor, the processor being adapted to perform the steps of: obtaining a query from a user; searching in a repository of legal reasoning graphs, wherein the searching is based on the query, wherein each legal reasoning graph in the repository is a graph composed of legal reasonings that cite one another, wherein each legal reasoning is one or more paragraphs extracted from a legal document, wherein in response to the searching, obtaining a result legal reasoning graph; and outputting the result legal reasoning graph.

Another exemplary embodiment of the disclosed subject matter is an apparatus for displaying a legal reasoning graph in a Graphical User Interface (GUI), wherein the legal reasoning graph comprising a plurality of legal reasonings connected by edges, wherein each legal reasoning is one or more paragraphs extracted from a legal document, wherein the legal document comprising additional text not comprised by the one or more paragraphs, wherein the apparatus having a processor, the processor being adapted to perform the steps of: presenting at least a first legal reasoning and a second legal reasoning and a connection indication between the first and second legal reasoning.

Yet another exemplary embodiment of the disclosed subject matter is a computer program product comprising a non-transitory computer readable medium retaining program instructions, which instructions when read by a processor, cause the processor to perform a method comprising: obtaining a query from a user; searching in a repository of legal reasoning graphs, wherein the searching is based on the query, wherein each legal reasoning graph in the repository is a graph composed of legal reasonings that cite one another, wherein each legal reasoning is one or more paragraphs extracted from a legal document, wherein in response to the searching, obtaining a result legal reasoning graph; and outputting the result legal reasoning graph.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a flowchart diagram of a method, in accordance with some embodiments of the disclosed subject matter;

FIG. 2 shows a flowchart diagram of a method, in accordance with some embodiments of the disclosed subject matter;

FIG. 3 shows a block diagram of an apparatus, in accordance with some exemplary embodiments of the disclosed subject matter; and

FIG. 4 shows an illustration of a GUI, in accordance with some embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with the disclosed subject matter is to provide a search engine which takes into account the evolvement of the legal reasoning over time. As legal reasoning may evolve over time and over a variety of legal documents, when performing a legal research one may be interested in understanding the development of the legal reasoning over time, to identify those cases which are given great weight and review specific applications of the reasoning on various instances. In some exemplary embodiments, a search engine capable of searching for an evolvement of the legal reasoning over time may be desired. Additionally or alternatively, the search engine may avoid treating each legal document or each legal reasoning separately, but instead take into account the context of the evolvement of the legal rule over a variety of legal reasonings over time.

A legal document, such as a decision, a ruling, a case law document, a paper, a book, a textbook, a treatise, or the like may depict a legal reasoning. The legal reasoning may be a portion of the text of the legal document, such as a sentence a paragraph, several paragraphs (optionally, consecutive paragraphs), or the like, which substantially addresses a single issue. In some exemplary embodiments, the legal reasoning is not the entire legal document and a single legal document may contain several legal reasonings, each of which may address different rules of law, different application of the law, or the like. The legal reasoning may base its contentions on previous legal reasonings by citing their containing sources. In some cases, the citation may cite the legal document but may not indicate to which portion of the text it refers to in the cited legal document and therefore may not provide clear indication of the cited legal reasoning.

Another technical problem may be providing a Graphical User Interface (GUI) useful for reviewing a chain of legal reasonings that depict evolution of a legal rule. The user may be interested in reviewing the entire development of the legal rule, such as reviewing relevant reasoning in previous cases which were overturned in process of establishing current law, identifying cases which apply the same legal reasoning on specific cases, or the like.

One technical solution provided by the disclosed subject matter is to utilize a legal reasoning graph, such as to allow users to search from a repository of pre-processed or dynamically generated legal reasoning graphs.

A legal reasoning graph can be a graph that comprises legal reasonings which cite one another. Each node in the graph may be a legal reasoning extracted from a legal document (e.g., a sentence, a paragraph, or several paragraphs included in the legal document). An edge in the graph may be included to indicate that the legal reasoning cites another legal reasoning. Such an indication may be based on a citation by the citing legal reasoning of a legal document comprising the cited legal reasoning. The cited legal document may be analyzed to determine a cited legal reasoning within the cited legal document to which the legal reasoning refers. The identification of the cited legal reasoning may be automatic and based on analysis of both the citing and cited legal reasonings. In some cases, a cause of linkage between the two legal reasonings may be textual similarities between the two legal reasonings (e.g., using cosine similarity analysis). Additionally or alternatively, a cause of linkage may be that both legal reasonings share a same topic. The topic may be identified using automatic summarization, by identifying usage of terms in a taxonomy, such as taxonomy of legal terms which may or may not be hierarchical. Additionally or alternatively, Named Entity Recognition (NER) may be performed to enable linking two legal reasonings based on both of the reasonings referring to the same entity or same class of entities. In some exemplary embodiments, NER may allow to identify named entities in the reasoning and optionally allow to ignore such case-specific names which may not be considered relevant for the purpose of the development of the legal rule. In some exemplary embodiments, legal reasoning graph may include properties of edges, such as indicating the cause of linkage.

In some exemplary embodiments, the graph may be a Directed Acyclic Graph (DAG). The cited legal reasoning can be associated with an incoming edge while the citing legal reasoning can be associated with an outgoing edge.

In some exemplary embodiments, edges or nodes may be assigned weights based on various parameters.

As one example, the weight may be based on a level of an authority which issued the legal document, such as a supreme court level, an appellate court level, a trial court level, an administrative level, a doctrine level in case the document is not a legal ruling, or the like.

As another example, the weights may be based on a type of reasoning. Reasonings may be categorized into classes such as mega reasonings which may indicate a widely accepted legal ruling, instance reasonings which apply the mega rulings in specific cases and build-up reasonings which form the basis for the mega reasonings. The categorization into the above-mentioned classes may be based on the number of incoming edges to and/or outgoing edges from the legal reasoning, based on the level of authority associated with the legal ruling, or the like. In some exemplary embodiments, in case the number of incoming edges divided by the sum of incoming and outgoing edges is above a threshold (either absolute or relative), the reasoning may be classified as a mega reasoning. Additionally or alternatively, mega reasoning may be detected based on topological arrangement of the graph. Additionally or alternatively, mega reasoning may be detected while taking into account the cause of linkage of each edge associated to it, such as by identifying that a specific legal term is the cause of linkage of a relatively large portion of the incoming edges. In some exemplary embodiments, each edge may be associated with a vector of terms and their relevance score that indicates the cause of linkage and mega reasonings may be detected based on weighted graph centrality algorithm which may or may not be based on all the terms in the vector or a portion thereof. Build-up reasonings may be identified as reasonings which form the basis of the mega reasoning and are not, themselves, mega reasonings. In some exemplary embodiments, build-up reasonings may be identified by traversing outgoing edges from the mega reasonings. In some exemplary embodiments, build-up reasonings may be non mega reasonings which are cited directly by a mega reasoning. Additionally or alternatively, instance reasonings may be identified as reasonings which are based on the mega reasoning, either directly or indirectly and are not themselves mega reasonings. In some exemplary embodiments, sentiment analysis may be used to differentiate between instance reasonings of a former mega reasoning and build up reasonings of a new mega reasoning. In some exemplary embodiments, a single reasoning may be both a build up reasoning and an instance reasoning. In some exemplary embodiments, mega reasonings may be determined using machine learning algorithms such as supervised and unsupervised learning methods.

As another example, the weights may be based on the topography of the graph, such as providing cut nodes or cut edges a different weight, such as a reduced or increased weight. Centrality in the graph may also be used to assign weights to nodes or edges. Other topography characteristics may be utilized in determining the weights.

As another example, the weights may be based on a type of citation. There may be different types of citations such as citation for applying another reasoning on a specific fact pattern, citation concurring with the cited decision, citation dissenting from the cited decision or overturning the cited decision, or the like.

In some exemplary embodiments, the search may be performed by utilizing inverted index to identify potential matches to a query. Potential matches may be ranked based on cosine similarity between each of them and the query. The ranking or searching for potential matches, generally referred together as the search, may also take into account metadata of the legal reasoning graph such as weights of nodes, edges, or the like. The disclosed subject matter may enable providing a single search result that represents the development of a legal rule over time. In some cases, one or more legal reasonings appearing in the graph may not be considered relevant to the query themselves but may be accessible as they are comprised by the graph that is considered relevant. As an example, in case a query for a term is performed, a legal reasoning not using the term but instead using a synonym or a generalization may not be considered relevant to the query. However, if the legal reasoning is part of a graph that makes use of the term, the entire graph may be returned as part of the search result, allowing the user to review the allegedly not relevant query.

Another technical solution is to provide a GUI for displaying a legal reasoning graph to the user. The GUI may be configured to show the user the legal reasoning graph or a portion thereof, indicating metadata relating to the entire graph, to edges or nodes in the graph, in addition to or instead of content of the legal reasoning appearing in the graph.

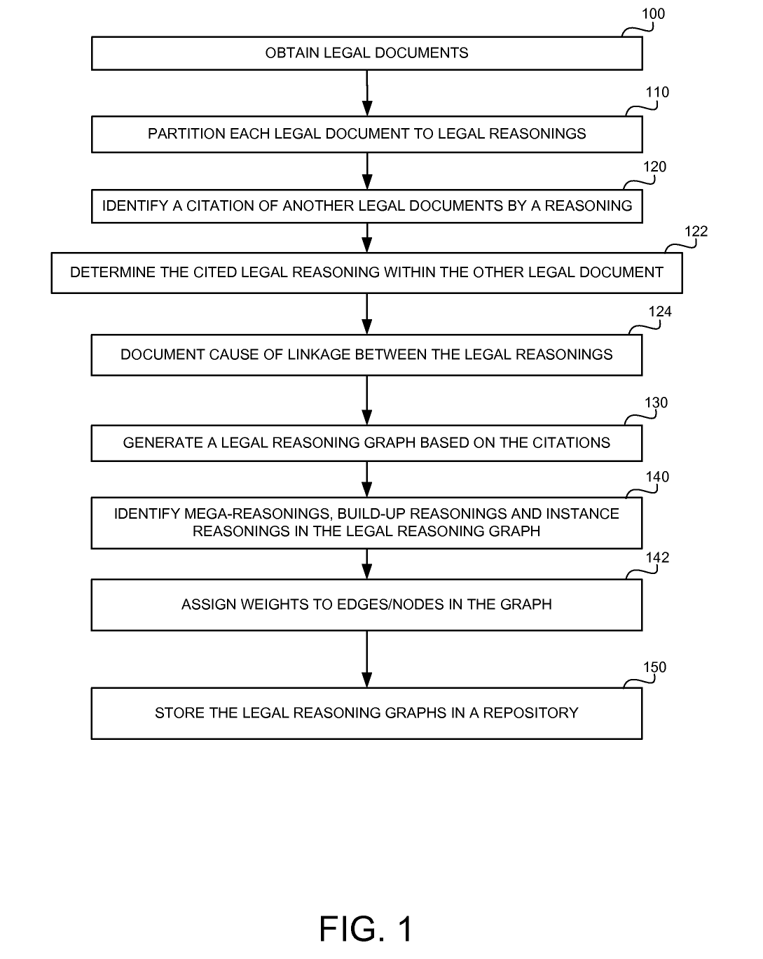

Referring now to FIG. 1 showing a flowchart diagram of a method, in accordance with some embodiments of the disclosed subject matter.

In Step 100, legal documents may be obtained. The legal documents may be obtained in electronic format. In some exemplary embodiments, the legal documents may be obtained from a repository of legal documents.

In Step 110, each legal document is partitioned into one or more legal reasonings. The document may be partitioned to text portions which are determined to be referring to a single concept, idea, rule, or the like. The document may be automatically partitioned based on textual similarity between sentences, paragraphs, or the like. Automatic partitioning may be performed using automatic topic summarization of each sentence, paragraph, or portion of text and may be based on identification of cut points in which the topic is changed in the document. In some exemplary embodiments, portions of the document may be removed, such as paragraphs listing arguments of the parties in a court decision, paragraphs which depict the factual pattern, or the like.

In Step 120, a citation in a legal reasoning of another legal document may be identified. The citation may refer to a legal document. In some exemplary embodiments, some citations may refer to a portion of the legal document, such as by citing page numbers. As an example, legal reasoning which is found in document A may cite document B, or specific pages in document B.

In Step 122, the cited reasoning within the cited legal document is determined. The determination may be automatic and it may be based on identification of similarity between the citing legal reasoning and the cited legal reasoning, such as, for example, using cosine similarity measurement. Additionally or alternatively, the determination may take into account NER analysis to determine if both legal reasonings refer to a same entity or a same class of entities. Additionally or alternatively, the determination may be based on automatic topic summarization or manual topic definition of each legal reasoning and similarities in the topics. In some cases, legal taxonomy may be utilized in determining similarities between topic and/or legal reasonings.

In Step 124, a cause of linkage between the legal reasonings may be documented. In some cases, the citation may not identify which legal reasonings in the cited document are referred to, because it may cite sections which comprise several legal reasonings. In some exemplary embodiments, shared keywords in the paragraphs may be stored. Additionally or alternatively, the shared one or more topic may be stored. The documented cause of linkage may be used when processing legal reasoning graph that comprise the citing and cited legal reasonings. In some exemplary embodiments, the cause of linkage may be stored as a property of an edge of the graph which is associated with the citation.

In Step 130, a legal reasoning graph may be generated. The legal reasoning graph may be generated based on the cited legal reasonings. The graph may be composed of nodes, each of which represents a legal reasoning. The nodes of the graph may be connected by edges. An edge may be associated with a citation, such as directed edge from node A to node B may be indicative that the legal reasoning of node A cited the legal reasoning of node B. The edge may be based on the determination in Step 120, in which a citation to a legal document containing the legal reasoning of node B is examined to identify that the citation is of node B. In some exemplary embodiments, the legal reasoning graph does not comprise edges for every citations appearing in a single legal document, as some citations may be appearing in a legal reasoning that is not part of the graph. As an example, a single document may comprise two legal reasonings: LR₁ and LR₂. As the graph may comprise LR₁ but not LR₂, the graph may not indicate edges representing citations by LR₂, which may potentially be included in another graph.

In some exemplary embodiments, metadata associated with edges, nodes, or the like may be retained, such as properties of nodes and edges. The metadata may be determined during the generation of the legal reasoning graph, such as based on content of legal reasonings, connectivity between the legal reasonings, properties of the legal documents, or the like.

In Step 140, class of reasoning may be determined for each reasoning (e.g., mega reasoning, instance reasoning, build-up reasoning, or the like).

In Step 142, weights may be assigned to edges or nodes of the graph. Weights may be assigned based on topography analysis of the graph such as increasing weight of important nodes and edges in the graph. Weights may be assigned based on level of authority issuing the legal document containing the legal reasoning. In some exemplary embodiments, weights may be assigned based on type of citation. In some exemplary embodiments, sentiment analysis may be performed to determine type of citation. Sentiment analysis may use natural language processing, text analysis, computational linguistics, or the like to extract subjective information from the legal reasonings. The sentiment analysis may be used to extract which kind of sentiment the citation has. Based on the sentiment analysis, the citation may be classified to different types. The type of citation may, for example, a dissenting citation, a concurring citation, an overturning citation, a concurring or dissenting in part citation, a citation applying the cited reasoning, or the like. In some exemplary embodiments, graph centrality may be used over time to identify a change in sentiment. As an example, if the number of references to a reasoning decrease after an evolvement in another case—the other case may be estimated to be a turn point which overturned the reasoning. In some exemplary embodiments, a weight of a node may be affected by a number of citations (e.g., incoming edges) to the node. Similarly, a weight of an edge may be affected by a number of citations to the outgoing node. The number of incoming edges to a node may affect centrality analysis of the graph, identification of mega reasonings and the like. In some exemplary embodiments, metadata associated with central nodes or edges may be given more weight in the metadata of the graph itself.

In Step 150, the legal reasoning graph may be stored in a repository. In some exemplary embodiments, based on the legal documents a plurality of graphs may be generated and stored. In some exemplary embodiments, the method of FIG. 1 may be performed as a pre-processing method once new documents are obtained. In some exemplary embodiments, in case a new document is obtained, it may be analyzed to add nodes to existing graphs based on its citations and citations thereof.

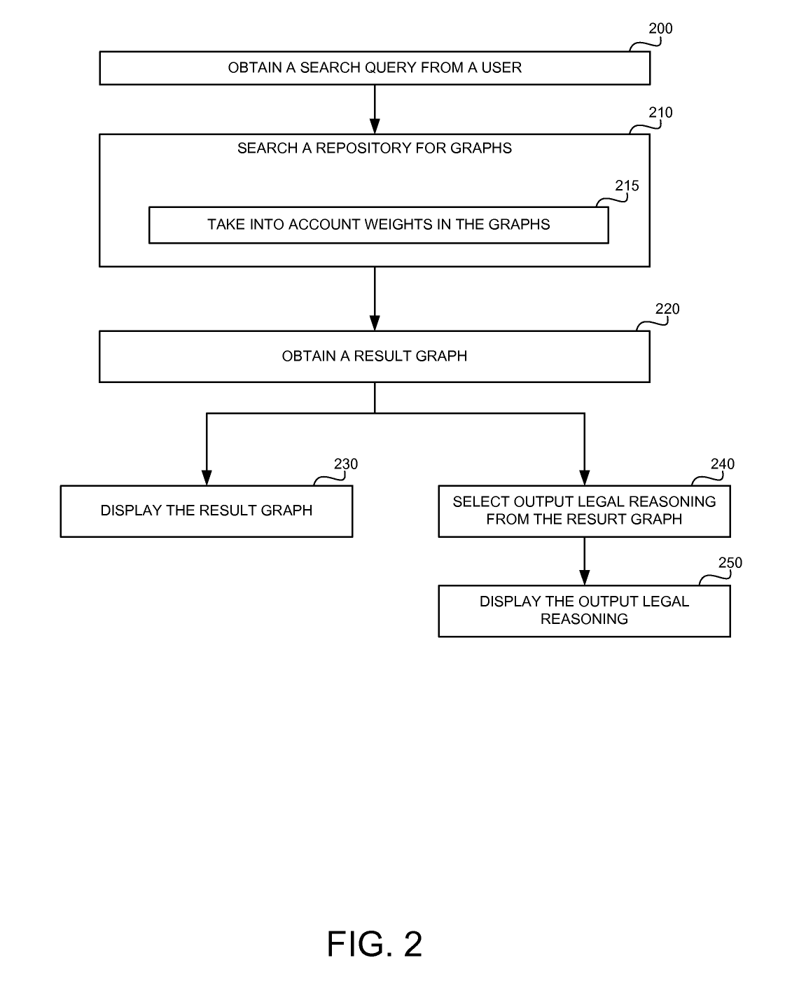

Referring now to FIG. 2 showing a flowchart diagram of a method, in accordance with some embodiments of the disclosed subject matter.

In Step 200, a search query is obtained from a user. The search query may be a combination of keywords that the user searches for. In some exemplary embodiments, the search query may be a legal proposition or a proposed legal reasoning that the user would like to find basis for, such as “suspect is entitled to a phone call”.

In Step 210, a repository of legal reasoning graphs may be searched for matches. In some exemplary embodiments, the matches may be identified based on an inverted index and scored based on similarity measurement between the potential matches and the query. In some exemplary embodiments, the search may take into account properties of the graph, such as properties of edges or nodes. As an example, the search may take into account cause of linkage, topic summary of the graph, or the like. In some exemplary embodiments, the search may utilize cosine similarity between the query and the graph.

In some exemplary embodiments, weights assigned to edges, nodes, or the like, may be taken into consideration in the search (215). The weights may be pre-assigned or assigned on line when the search is performed. The weights may cause to shift focus of the search to portions of the graph that may be deemed more important, such as nodes or edges that are topographically central, decisions by higher levels of authority, good law that was not overturned and was often cited in concurrence and applied on various instances, mega reasonings, or the like. As an example, if a keyword appears in a graph in a reasoning by a trail court which was overruled or dissented later it may be given smaller weight in determining the relevancy of the graph than a keyword appearing in a mega reasoning by a supreme court.

It will be appreciated that the search of Step 210 is a search of a graph and not of a single legal document or a single legal reasoning. A result graph is obtained (220), such as a graph that is deemed most relevant to the search query. In some exemplary embodiments, a list of result graphs may be obtained, and they may be ordered based on their determined relevancy score.

In Step 230, the result graph may be displayed. The result graph may be displayed in its entirety. Additionally or alternatively, a portion of the result graph may be displayed. A GUI component may be used to allow a user to traverse the result graph and view content of its nodes, and associated metadata.

In Step 240, an output legal reasoning may be selected from the result graph. The output legal reasoning may be automatically selected based on relevance measurement to the query so as the selected legal reasoning may be the most relevant legal reasoning to the query within the graph. Additionally or alternatively, the selection may be based on importance measurement of the legal reasonings within the legal reasoning graph, such as giving higher importance measurement to central reasonings which are often cited, to reasonings by higher level authorities, to reasonings that are considered mega reasonings, or the like, to reasonings that cite many references and are therefore can be considered as thorough, or the like. By using importance measurement the selection of the output legal reasoning is not based on how relevant the legal reasoning is to the query but rather it is based on how important it is in the graph that is deemed most relevant. In some exemplary embodiments, a combination of importance and relevance measurement may be used. Other parameters may be used in the selection as well.

In Step 250, the selected output legal reasoning is displayed. In some exemplary embodiments, a GUI component may present the graph and highlight the output legal reasoning. The GUI component may display the text of the output legal reasoning in addition to or instead of the display of the graph itself.

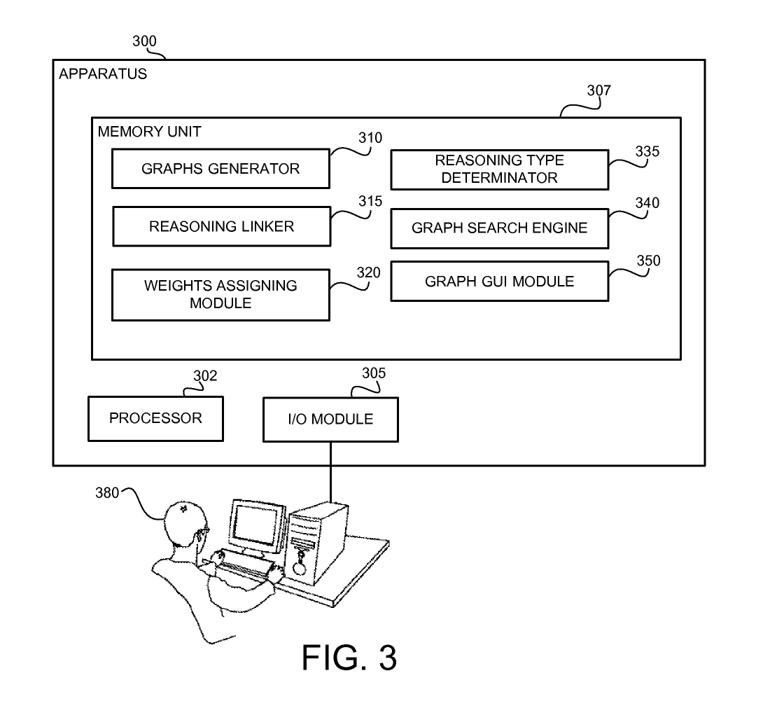

Referring now to FIG. 3 showing a block diagram of an apparatus, in accordance with some exemplary embodiments of the disclosed subject matter. An Apparatus 300 may be a computerized apparatus adapted to perform methods such as depicted in FIG. 1 and FIG. 2. In some exemplary embodiments, Apparatus 300 may be implemented in whole or in part using web-based technologies, cloud computing, or the like.

In some exemplary embodiments, Apparatus 300 may comprise a Processor 302. Processor 302 may be a Central Processing Unit (CPU), a microprocessor, an electronic circuit, an Integrated Circuit (IC) or the like. Alternatively, Apparatus 4300 can be implemented as firmware written for or ported to a specific processor such as Digital Signal Processor (DSP) or microcontrollers, or can be implemented as hardware or configurable hardware such as field programmable gate array (FPGA) or application specific integrated circuit (ASIC). Processor 302 may be utilized to perform computations required by Apparatus 300 or any of it subcomponents.

In some exemplary embodiments of the disclosed subject matter, Apparatus 300 may comprise an Input/Output (I/O) Module 305 such as a terminal, a display, a keyboard, an input device or the like to interact with the system, to invoke the system and to receive results. It will however be appreciated that the system can operate without human operation.

In some exemplary embodiments, the I/O Module 305 may be utilized to provide an interface to a User 380 to interact with Apparatus 300, such as to present the display to User 380, to allow User 380 to provide a query and interact with presented reasoning graphs, or the like.

In some exemplary embodiments, Apparatus 300 may comprise a Memory Unit 307. Memory Unit 307 may be persistent or volatile. For example, Memory Unit 307 can be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like. In some exemplary embodiments, Memory Unit 307 may retain program code operative to cause Processor 302 to perform acts associated with any of the steps shown in FIG. 1 and FIG. 2.

The components detailed below may be implemented as one or more sets of interrelated computer instructions, executed for example by Processor 302 or by another processor. The components may be arranged as one or more executable files, dynamic 25 libraries, static libraries, methods, functions, services, or the like, programmed in any programming language and under any computing environment.

Graphs Generator 310 may be configured to generate legal reasoning graphs. The legal reasoning graph may be generated based on legal documents. Additionally or alternatively, Graphs Generator 310 may be configured to update existing graphs to introduce additional legal reasonings, based on newly added documents. Graphs Generator 310 may be used in performing Step 130 of FIG. 1.

Reasoning Linker 315 may be configured to link two legal reasonings from two different legal documents. In some exemplary embodiments, Reasoning Linker 315 may be configured to determine to which legal reasoning a citation refers. Reasoning Linker 315 may be configured to output a cause of linkage, which may or may not be retained. In some exemplary embodiments, Graphs Generator 310 may utilize Reasoning Linker 315 to connect reasonings in the graph. The cause of linkage may be retained as metadata of edges. Reasoning Linker 315 may be used in performing Steps 120, 122, 124 of FIG. 1.

Weights Assigning Module 320 may be configured to assign weights to legal reasoning in the graph (e.g., nodes), to edges connecting legal reasonings in the graph, or the like. The weights may be based on topography of the graph, on level of authorities deciding the reasoning, on sentiment analysis, type of reasoning or the like. In some exemplary embodiments, Weights Assigning Module 320 may be used to perform Step 142 of FIG. 1.

Reasoning Type Determinator 335 may be configured to determine a type of reasoning. The type of reasoning may be a mega reasoning, an instance reasoning, a buildup reasoning, or the like. In some exemplary embodiments, Reasoning Type Determinator 335 may be used to perform Step 140 of FIG. 1. Additionally or alternatively, Reasoning Type Determinator 335 may be utilized by Weights Assigning Module 320 to determine the weights.

Graph Search Engine 340 may be configured to search for reasoning graphs based on a query. Graph Search Engine 340 may be used in performing the Step 210 of FIG. 2. The search may be performed with respect to a repository of legal reasoning graphs (not shown). Graph Search Engine 340 may utilize similarity measurement to rank potential matches. The similarity measurement may be based on cosine similarity or on other similarity metrics. The similarity measurement may be computed between the query and parameters of the graph, in addition to or instead of the content of the legal reasonings that are comprised by the graph. As an example, the similarity measurement may be computed solely with respect to the recorded causes of linkage.

In some exemplary embodiments, the query may be processed prior to performing the search, such as performing NER in the query, identifying statutes in the query, identifying citations in the query, or the like. The query processing may be useful for providing better matches.

It will be noted that the repository may retain pre-processed legal reasoning graphs or may generate the legal reasoning graphs on the fly in response to the query. In some exemplary embodiments, the repository may be local, remote, or the like.

Graph GUI Module 350 may be configured to display a legal reasoning graph. Additionally or alternatively, Graph GUI Module 350 may provide an interactive GUI to allow user to review portions of the legal reasoning graph, review the legal reasonings within the graph, legal documents associated with the legal reasoning graph, review metadata of the graph, or the like. In some exemplary embodiments, the Graph GUI Module 350 may be initialized to focus on a legal reasoning within the legal reasoning graph, such as a mega reasoning within the graph, the most relevant legal reasoning to a query in the graph, the legal reasoning having the highest importance measurement, or the like. In some exemplary embodiments, Graph GUI Module 350 may be used to output results of a search query. Additionally or alternatively, the GUI may be useful in displaying any legal reasoning graph, including a graph that is not obtained as a result of a search.

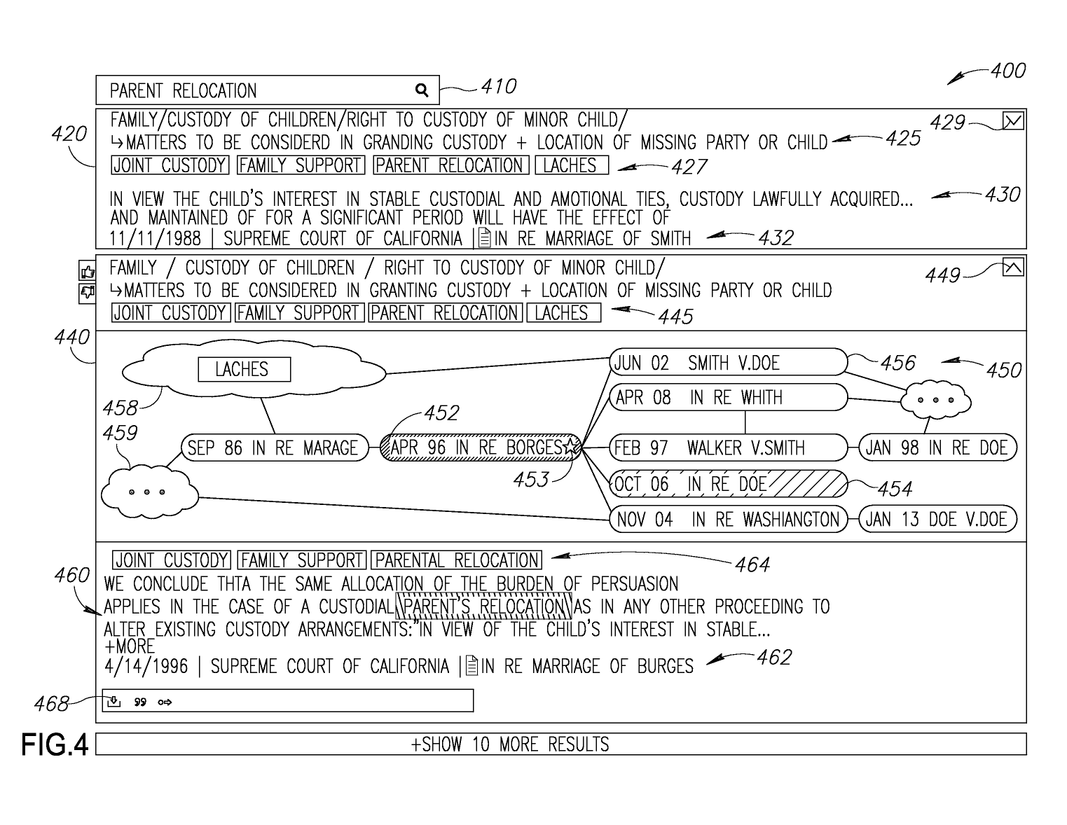

Referring now to FIG. 4 showing an illustration of a GUI, in accordance with some embodiments of the disclosed subject matter. GUI 400 may be a GUI that displays information to a user, such as 380 of FIG. 3. Additionally or alternatively, GUI 400 may display to a user metadata associated with a legal reasoning graph. In some exemplary embodiments, GUI 400 may display a selected legal reasoning and optionally associated metadata.

A Query Box 410 may be used by a user to input a search query. In response to a query, a search may be performed, such as using Graph Search Engine 340 of FIG. 3. One or more results of the query may be presented. The results may be ordered in accordance with a relevancy metric, such as similarity between the graph or metadata thereof and the query.

As an example, Result 420 and Result 440 may be displayed. In some exemplary embodiments, additional results may be displayed on request.

Result 420 is displayed in a summary display, in which a graphical representation of the legal reasoning graph is not displayed. A toggle button, such as 429 and 449, may be operative to switch between a summary display and a full display. Result 440 is exemplified as being displayed in a full display, where the graphical representation of the legal reasoning graph is displayed to the user.

Topic 425 may be automatically generated and indicating a topic of the legal reasoning graph. Topic 425 may be displayed based on a hierarchical taxonomy of legal concepts. Topic 425 may be automatically generated based on keywords appearing in the legal reasonings within the graph, based on causes of linkage, or the like. As exemplified in FIG. 4, the topic of Result 420 is “matters to be considered in granting custody+location of missing party or child” which is a sub-topic within the topic of “Rights to custody of minor child”, which is a sub-topic of “custody of children”, which in itself is a sub-topic of the general “family” topic.

Key Terms 427 may also be displayed. Key Terms 427 may be generated based on the content of the legal reasonings within the graph, based on causes of linkage, or the like. In some exemplary embodiments, a legal reasoning graph may be associated with a plurality of Key Terms 427 which may or may not be connected. As an example, the key term “laches”, which refers to a general legal concept which is applicable to many fields, may appear

Key Terms 427, Topic 425, and additional data may be displayed in a portion of the display dedicated to metadata of the legal reasoning graph.

In some exemplary embodiments, a display of a graph result may include a display of a selected legal reasoning. The selected legal reasoning may be selected from the graph, such as a legal reasoning that is manually selected by a user, automatically selected based on a metric (e.g., relevance metric to the query, importance metric in the graph, etc.), or the like. The selected legal reasoning or a portion thereof may be displayed in Text Portion 430. In some exemplary embodiments, Text Portion 430 may be extended to display the entire text of the selected legal reasoning. Reasoning Bibliography 432 may be used to display bibliography data of the selected legal reasoning, such as a date of the legal document (“11/11/1988”), an authority issuing the legal document (“Supreme Court of California”), name of the parties or citation of the document (“In re marriage of Smith”). In some exemplary embodiments, a hyperlink may be used to allow the user to access the legal document which contains the legal reasoning to allow review of the full document.

Referring now to Result 440 which exemplifies a full display of a result. Graph Display 450 may be used to graphically display the legal reasoning graph. Each legal reasoning in the graph may be represented using a node. Edges may be used to represent citations. For example, Node 456 may represent a legal reasoning from a legal document which is referred to as Smith V. Doe, which was issued on June 2002. As the legal reasoning represented by Node 456 cites a legal reasoning that is represented by Node 452, an edge, which may or may not appear to be directed, may connect the two nodes.

In some exemplary embodiments, a node, such as Node 456, may be annotated with information, such as, for example, a citation name of the legal document, date of the legal document, or the like. Other bibliographical information or metadata may also be used.

In some exemplary embodiments, the graphical display may display only a portion of the legal reasonings of the graph. The portion being displayed may be based on an importance metric, relevance metric, or the like. The portion may be based on user selection. In some exemplary embodiments, a GUI Element 459 may graphically represent that there are additional legal reasonings which cite or are cited by legal reasonings that are being displayed. In some exemplary embodiments, in response to a user interaction with GUI Element 459, such as clicking GUI Element 459 using a pointing device, additional legal reasonings may be displayed. In some exemplary embodiments, in response to displaying additional legal reasonings, some legal reasonings that are being displayed may be hidden away so as to provide user friendly Graph Display 450.

In some exemplary embodiments, a GUI Element 458 may indicate topic, key term, or the like that is depicted in undisplayed portion of the graph. As an example, the graph may refer to different key terms, such as the term “laches”. In some exemplary embodiments, sub-graphs of the graph that are associated with key terms may be hidden and can be displayed in response to an interaction with GUI Element 458. As an example, a legal reasoning graph may be associated with different legal concepts, such as concepts that are relevant to family law and to general concepts in equity such as laches. In case the query is associated with the family law portion of the graph, the laches portion of the graph may be hidden, as is exemplified in FIG. 4.

In some exemplary embodiments, properties of nodes may be graphically indicated, such as an indication of a sentiment of a citation. As an example, Node 454 may be a relatively negative citation of Node 452, as opposed to Node 456. The sentiment may be indicated using color, icon, or other visual indications. Additionally or alternatively, Node 452 may be indicated as a mega reasoning using a Mega Reasoning Icon 453. In some exemplary embodiments, build up reasoning and instances reasoning may also be indicated using icons, colors, or the like. In some exemplary embodiments, user input may be received to indicate whether the mega reasoning is correct or incorrect, thereby allowing usage of peer production methods to determine which of the reasonings is indeed a mega reasoning. Additionally or alternatively, machine learning may be utilized to adapt the mega reasoning identification algorithm based on the user input, such as supervised or unsupervised machine learning algorithms.

In some exemplary embodiments, a user may select a node from Graph Display 450. In some exemplary embodiments, a default selected node may be initially selected, such as based on relevance metric to a query, based on importance metric in the graph, combination thereof, or the like. Content and metadata associated with the node may be displayed in Node Display Portion 460. Node Display Portion 460 may comprise the text of the legal reasoning, metadata associated with the legal reasoning such as Key Terms 464, Bibliography 462, or the like.

In some exemplary embodiments, user may use an interaction panel, such as allowing to save the selected legal reasoning, quote the selected legal reasoning, share the selected legal reasoning, or the like. As an example, Icon 468 may be associated with saving the selected legal reasoning. In some exemplary embodiments, user interaction with the legal reasonings may be tracked over time to determine which legal reasoning is indeed a mega reasoning. Peer production methods may be employed to crowd-source desired information from the users. In some exemplary embodiments, machine learning algorithms may be used to enhance the mega reasoning identification algorithm based on user interaction over time.

In some exemplary embodiments, the disclosed subject matter may be implemented in different deployment methods such as a web-based system, a cloud-based system, local software, mobile app, or the like. In some exemplary embodiments, some of the features may be implemented on a client device, while others on backend servers. In some exemplary embodiments, backend servers may be utilized to implement some features in an offline manner and some features in an online manner.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An apparatus having a processor, the processor being adapted to perform the steps of:
obtaining a query from a user;
searching in a repository of legal reasoning graphs, wherein said searching is based on the query, wherein each legal reasoning graph in the repository is a graph composed of legal reasonings that cite one another, wherein each legal reasoning is one or more paragraphs extracted from a legal document,
wherein in response to said searching, obtaining a result legal reasoning graph; and
outputting the result legal reasoning graph.

2. The apparatus of claim 1, wherein said searching is performed using cosine similarity between the query and each legal reasoning graph.

3. The apparatus of claim 1, wherein each legal reasoning graph has edges each of which connects between a legal reasonings, wherein an edge connects a first legal reasoning included in a first legal document and a second legal reasoning included in a second legal document, only if the first legal reasoning cites the second legal document, wherein the second legal document comprises one or more paragraphs in addition to the second legal reasoning.

4. The apparatus of claim 3, wherein said searching is based on properties of the edges.

5. The apparatus of claim 4, wherein said searching comprises assigning weights to edges based upon topographical location within the legal reasoning graph.

6. The apparatus of claim 4, wherein the first and second legal documents are rulings, wherein said searching comprises assigning weights to edges based upon level of authority deciding the first and second legal documents.

7. The apparatus of claim 4, wherein the properties of the edges are a cause of linkage, wherein the cause of linkage indicates a reason for which the first legal reasoning is determined to be referring to the second legal reasoning with the second legal document.

8. The apparatus of claim 7, wherein the cause of linkage is selected from a group consisting of:
textual similarities between the first and second legal reasonings;
the first and second legal reasonings having a same topic; and
the first and second legal reasonings referring to a same entity or same class of entities.

9. The apparatus of claim 4, wherein the properties of the edges include a sentiment classification indicating a type of citation by the first legal reasoning of the second legal reasonings.

10. The apparatus of claim 9, wherein the type of citation is selected from a group consisting of:
the first legal reasoning applying the second legal reasoning;
the first legal reasoning dissenting from the second legal reasoning;
the first legal overturning the second legal reasoning; and
the first legal reasoning concurring with the second legal reasoning;

11. The apparatus of claim 1, wherein said outputting comprises:
selecting an output legal reasoning from the result legal reasoning graph; and
presenting to the user the output legal reasoning.

12. The apparatus of claim 11, wherein said selecting comprises selecting the output legal reasoning based on a relevance measurement to the query.

13. The apparatus of claim 11, wherein said selecting comprises selecting as the output legal reasoning based on an importance measurement in the legal reasoning graph.

14. An apparatus for displaying a legal reasoning graph in a Graphical User Interface (GUI), wherein the legal reasoning graph comprising a plurality of legal reasonings connected by edges, wherein each legal reasoning is one or more paragraphs extracted from a legal document, wherein the legal document comprising additional text not comprised by the one or more paragraphs, wherein the apparatus having a processor, the processor being adapted to perform the steps of: presenting at least a first legal reasoning and a second legal reasoning and a connection indication between the first and second legal reasoning.

15. The apparatus of claim 14, wherein said presenting comprises displaying, with respect to the first legal reasoning, an indication as to a parameter selected from a group consisting of:
type of citation by the first legal reasoning;
type of citation of the first legal reasoning;
cause of linkage of the first legal reasoning with the second legal reasoning;
level of an authority associated with the legal document comprising the first legal reasoning; and
time in which the legal document comprising the first legal reasoning was created.

16. The apparatus of claim 14, wherein said presenting comprises displaying, with respect to the first legal reasoning, an indication as to whether the first legal reasoning is a build-up reasoning, a mega reasoning or an instance reasoning.

17. The apparatus of claim 14, wherein said presenting comprises displaying an automatically generated summarization of the legal reasoning graph based on content of the legal reasonings comprised by the legal reasoning graph.

18. The apparatus of claim 17, wherein the automatically generated summarization is generated by aggregating causes of linkage of legal reasonings in the legal reasoning graph.

19. The apparatus of claim 14,
wherein the legal reasoning graph comprises a first and second portion;
wherein said presenting comprises displaying the first portion of the legal reasoning graph, and wherein the second portion of the legal reasoning graph is presented using an abstract representation of the second portion and without explicitly presenting the legal reasonings comprised by the second portion; and
wherein said GUI is responsive to user input, wherein in response to user input, the GUI replaces the abstract representation of the second portion with an explicit representation of at least one legal reasoning comprised by the second portion.

20. A computer program product comprising a non-transitory computer readable medium retaining program instructions, which instructions when read by a processor, cause the processor to perform a method comprising:
obtaining a query from a user;
searching in a repository of legal reasoning graphs, wherein said searching is based on the query, wherein each legal reasoning graph in the repository is a graph composed of legal reasonings that cite one another, wherein each legal reasoning is one or more paragraphs extracted from a legal document,
wherein in response to said searching, obtaining a result legal reasoning graph; and
outputting the result legal reasoning graph.
